(19) United States
(12) Patent Application Publication
(10) Pub. No.: US 2005/0189834 A1
(43) Pub. Date: Sep. 1, 2005

(54) Rotating machines, insulation coils, and epoxy resin composition for rotating machines and insulation coils

(75) Inventors: Kenji Ikeda, Hitachi (JP); Syoichi Maruyama, Yamatsuri (JP); Yoshihiro Haraguchi, Hitachi (JP); Misao Souma, Hitachi (JP); Takeshi Nakayama, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Tokyo (JP)

(21) Appl. No.: 11/063,873

(22) Filed: Feb. 23, 2005

(30) Foreign Application Priority Data
Feb. 27, 2004 (JP) 2004-052653

(51) Int. Cl. H02K 3/04; H02K 1/00

(52) U.S. Cl. 310/179; 174/120 R; 310/208; 174/110 SR

(57) ABSTRACT

In order to offer the epoxy resin composition allowing much lower viscosity and higher heat resistance (glass transition temperature) of cured product to coexist and lowering hygroscopic property, and the insulation coil and one-piece impregnation type rotating machine with improved insulation performance using the composition, the epoxy resin composition made of a mixture of 1 to 5 by weight of sulfonium salt cationic polymerization initiator and 3 to 15 by weight of reactive diluent with 100 by weight of epoxy resin is provided. The insulation coil that is an insulation coil made of plain conductor wire formed into a specified shape and wound with insulation material, impregnated with the epoxy resin composition and then cured is provided. In addition, one-piece impregnation type rotating machine consisting of a stator constructed as follows and a rotor: that is, an insulation coil made of conductor formed into a specified shape and covered with insulation material is mounted into an iron core slot, and then piles and wedges are inserted into the inner circumferential grooves of the iron core slot and the insulation coil is connected at the outside edge of the iron core, and then an assembly of the insulation coil and iron core is impregnated with the epoxy resin composition and cured.

### BACKGROUND OF THE INVENTION

The present invention relates to rotating machines, insulation coils, and epoxy resin composition for them, and particularly to epoxy resin composition exhibiting long pot life, low viscosity as well as high heat resistance of cured product, and low hygroscopic property and also to one-piece impregnation type rotating machines and insulation coils using the epoxy resin composition.

There has been an increasing need for compactness and light weight, reduced cost, and enhanced performance of high-voltage rotating machines including rotating machine for vehicle and induction motor for general industrial application.

Available manufacturing method of stator for high-voltage rotating machine (consisting mainly of insulation coil and iron core) includes an individual prepreg method, individual impregnation method, and one-piece impregnation method.

(1) Individual prepreg method: Plain conductor wire formed into a specified shape is coiled using prepreg mica tape and the cured insulation coil is mounted into an iron core slot.

(2) Individual impregnation method: Plain conductor wire formed into a specified shape is coiled using insulation material and the produced insulation coil is impregnated with epoxy resin composition under vacuum and pressure, and the heat-cured insulation coil is then mounted into an iron core slot.

(3) One-piece impregnation method: The insulation coil made of plain conductor wire formed into a specified shape and covered with insulation material is mounted into an iron core slot, and then piles and wedges are inserted into the inner circumferential grooves of the iron core slot and the insulation coil is connected at the outside edge of the iron core. After this, an assembly of the insulation coil and iron core is impregnated with epoxy resin composition under vacuum and pressure and then heat-cured so as to form the insulation coil and iron core into one piece.

Particularly in case of a stator manufactured by the one-piece impregnation method, since the insulator coil and iron core are made into one piece where the gaps between the insulation coil and iron core slot and minute portions of the insulation layer consisting of mica tape are all insulated with epoxy resin composition, adhesion between the insulation coil and iron core increases and so heat radiating property (thermal conductivity) can improve, which is advantageous because rotating machine itself can enjoy excellent cooling performance. Additionally, the production process (time) and component material can be simplified, which is also advantageous because product cost can decrease. With these advantages, the one-piece impregnation method is becoming a major method for insulation of small and medium size high-voltage rotating machines.

The epoxy resin composition used for one-piece impregnation type rotating machines manufactured by the above one-piece impregnation method is used repeatedly in large volume in an impregnation bath, and so its waste must be reduced drastically so as to lighten the load onto the global environment. For this purpose, it is important that the epoxy resin composition applied to one-piece impregnation type rotating machines shall not only have further extended pot life but also meet the following subjects.

Subjects (characteristic requirements) for the epoxy resin composition for one-piece impregnation type rotating machine are:

(1) In order to improve the impregnation of the epoxy resin composition into the gaps between the insulation coil and iron core of stator and minute portions of the insulation layer, viscosity in a practical application temperature range from 25° C. to 40° C. shall further be lowered. This is because insufficient impregnation results in lower electrical reliability.

(2) In order to improve the mechanical and electrical reliability of rotating machine at higher operating temperature, heat resistance (mainly glass transition temperature) of cured product of the epoxy resin composition shall be improved.

For the epoxy resin composition for one-piece impregnation type rotating machine is required to allow two opposing properties to coexist, that is, much lower viscosity and higher heat resistance of cured product. In addition, increased glass transition temperature correlates generally with reduced pot life.

And also,

(3) Hygroscopic property needs to be lowered so as to prevent deterioration and improve stability during the storage in impregnation equipment.

Major prior arts that attempted to improve various performances of the epoxy resin composition applied to rotating machines include the following known methods.

For example, according to a method disclosed in the Japanese Application Patent Laid-open Publication No. 2000-239356 (Patent Document 1), acid anhydride curing agent and curing accelerator are applied to the epoxy resin composition, of which curing accelerator being cationic polymerization type accelerator and organic metallic salt or tetra phenyl borate or boron trichloride amine complex so as to improve the storage stability (pot life) of the epoxy resin composition.

On the other hand, for the epoxy resin composition for ordinary rotating machines manufactured by the individual impregnation method, the Japanese Application Patent Laid-open Publication No. 2000-297204 (Patent Document 2) discloses a method where cationic polymerization initiator and ion absorbent for catching ions so as to minimize gelation reaction are mixed with the epoxy resin composition and also inorganic filler is employed as needed so as to improve the storage stability (pot life) and high-temperature tanδ.

In addition, the Japanese Application Patent Laid-open Publication Nos. HEI 10-152469 (Patent Document 3), HEI 10-251375 (Patent Document 4), HEI 11-29609 (Patent Document 5), and 2003-26766 (Patent Document 6) disclose a method where the epoxy resin composition uses sulfonium salt as curing agent for epoxy resin so as to improve the curing property in heating and storage stability.

However, because the prior art disclosed in the Japanese Application Patent Laid-open Publication No. 2000-239356 (Patent Document 1) uses acid anhydride curing agent for the epoxy resin composition, curing reaction progresses little by little even if the epoxy resin with acid anhydride curing agent is not subjected to the acceleration by the curing accelerator. Consequently, thermal latent curing property of the cationic polymerization type curing accelerator and organic metallic salt is reduced and, furthermore, the acid anhydride curing agent itself crystallizes (ring opening of reactive functional group) due to the effect by moisture in the air depending upon the storage (preservation) condition of the epoxy resin composition, resulting in deterioration of storage stability and pot life.

The Japanese Application Patent Laid-open Publication No. 2000-297204 (Patent Document 2) considers the storage stability and tanδ of the epoxy resin composition but no consideration is given as to allow the two opposing properties to coexist, i.e. much lower viscosity and higher heat resistance (glass transition temperature) of cured product. Furthermore, since the ion absorbent to be added to improve the storage stability is powder, it causes the viscosity of the epoxy resin composition to increase. Thus, it is not suitable for one-piece impregnation type rotating machines where the epoxy resin composition is required to have higher impregnation into minute portions such as between conductors. In the Japanese Application Patent Laid-open Publication Nos. HEI 10-152469 (Patent Document 3), HEI 10-251375 (Patent Document 4), and HEI 11-29609 (Patent Document 5), neither application to one-piece impregnation type rotating machines is disclosed nor any specific consideration is given on the coexistence of much lower viscosity of the epoxy resin composition and higher heat resistance (glass transition temperature) of cured product.

The Japanese Application Patent Laid-open Publication No. 2003-26766 (Patent Document 6) considers much lower viscosity of the epoxy resin composition and higher heat resistance (glass transition temperature) of cured product, but further lower viscosity is needed for the application to one-piece impregnation type impregnation rotating machines.
[Patent Document 1] Japanese Application Patent Laid-open Publication No. 2000-239356
[Patent Document 2] Japanese Application Patent Laid-open Publication No. 2000-297204
[Patent Document 3] Japanese Application Patent Laid-open Publication Nos. HEI 10-152469
[Patent Document 4] Japanese Application Patent Laid-open Publication No. HEI 10-251375
[Patent Document 5] Japanese Application Patent Laid-open Publication No. HEI 11-29609
[Patent Document 6] Japanese Application Patent Laid-open Publication No. 2003-26766

### SUMMARY OF THE INVENTION

An object of the present invention is to provide the epoxy resin composition with coexisting much lower viscosity and higher heat resistance of cured product and also with low hygroscopic property so as to improve the insulation performance of insulation coil and one-piece impregnation type rotating machine. Another object is to extend the pot life of the epoxy resin composition.

The epoxy resin composition of the present invention for achieving the above object is the one that applies thermal latent curing agent and reactive diluent to epoxy resin, where 1 to 5 by weight of sulfonium salt cationic polymerization initiator as the thermal latent curing agent and 3 to 15 by weight of reactive diluent are contained in 100 by weight of epoxy resin, and that is liquid under normal temperature, practically containing no inorganic filler, acid curing agent or amine compound.

In addition, one-piece impregnation type rotating machine of the present invention is the one that is equipped with a stator manufactured in the following manner and a rotor: that is, an insulation coil made of plain conductor wire formed into a specified shape and wound with insulation material is mounted into an iron core slot, and then piles and wedges are inserted into the inner circumferential grooves of the iron core slot and the insulation coil is connected at the outside edge of the iron core, and then an assembly of the insulation coil and iron core is impregnated with the above epoxy resin composition and cured.

### BRIEF DESCRIPTION OF THE DRAWINGS

FIG. 1(a) is an overview of the insulation coil of the present invention and FIG. 1(b) is an enlarged cross-sectional view of the inside.

FIG. 2(a) is a cross-sectional front view of the stator of the present invention and FIG. 2(b) is an enlarged cross-sectional view of the iron core slot.

FIG. 3 is a cross-sectional oblique view of the one-piece impregnation type rotating machine of the present invention.

### DETAILED DESCRIPTION OF THE PREFERRED EMBODIMENTS

The epoxy resin composition for one-piece impregnation type rotating machine of the present invention and one-piece impregnation type rotating machine are described hereunder in detail.

The epoxy resin composition of the present invention is a composition containing epoxy resin, sulfonium salt cationic polymerization initiator and reactive diluent.

In particular, by adjusting the mixture balance of the sulfonium salt cationic polymerization initiator and reactive diluent added to the epoxy resin, the epoxy resin composition of the present invention has realized drastically extended pot life and also achieved the coexistence of opposing properties, i.e. much lower viscosity for better impregnation into the gaps between the insulation coil and iron core, minute portions of the insulation layer made of mica paper, etc. and higher heat resistance (glass transition temperature) of cured product for improving the mechanical and electrical reliability of rotating machine at higher operating temperature. Accordingly, the epoxy resin composition of the present invention is liquid exhibiting low viscosity under practically normal temperature (25° C. to 40° C.)

The epoxy resin compound of the present invention does not practically contain curing agent such as acid anhydride or amine compound. This is because mixed acid anhydride may cause deterioration such as crystallization (ring opening of reactive functional group) during storage or usage due to the effect of moisture contained in the air of stator to be impregnated. Accordingly, the epoxy resin composition of the present invention maintains lower hygroscopic property and exhibits excellent stability. It therefore hardly deteriorates even if managed or handled in the same manner as for ordinary epoxy resin.

Since the epoxy resin composition of the present invention is used for one-piece impregnation type rotating machines, adding no filler is more preferable. This is because, once inorganic filler such as silica and alumina sediments (separates) during usage or storage of the epoxy resin composition due to the difference of specific gravity, it is difficult to disperse it together with the resin component evenly again and also because, since inorganic filler cannot penetrate smoothly into the gap between insulation coils or between insulation layers or minute gaps at the contact points of slots, piles and wedges, impregnating ability of the epoxy resin composition may be deteriorated. Mixture of polymer particle is not recommended either for the one-piece impregnation type rotating machine application because it may deteriorate the impregnating ability of the epoxy resin composition.

Accordingly, in order to best utilize the above features of the present invention, the epoxy resin composition of the present invention does not contain inorganic filler such as silica or alumina practically.

Each material used for the epoxy resin composition of the present invention is described hereunder.

<Epoxy Resin>

Epoxy resin used in the present invention is in no way limited so far as it is liquid at the time of impregnation. In view of low viscosity requirement, it shall preferably be liquid in a room temperature range (25° C. to 40° C.). Any known crystallized (solid) epoxy resin is also applicable without limitation provided that it becomes liquid when two or more solid types or solid and liquid types are mixed or when it is mixed with reactive diluent. For example, epoxy resin types shown below as chemical compound are bisphenol A type epoxy resin, bisphenol F type epoxy resin, bisphenol A/F type epoxy resin which is a mixture of the above A type and F type, and resorcin type epoxy resin, which can be used alone or in mixture of two or more types.

[Chemical Formula 1]

Bisphenol A type epoxy resin

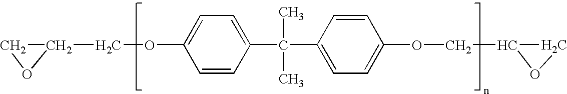

[Chemical Formula 2]

Bisphenol F type epoxy resin

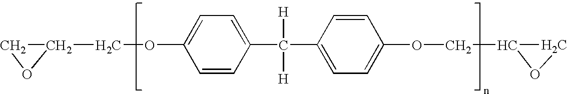

[Chemical Formula 3]

Resorcin type (resorcinol type) epoxy resin [Product name mentioned in the Specification: EX-201]

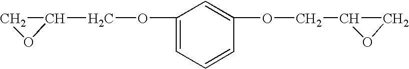

<Polymerization Initiator>

Sulfonium salt cationic polymerization initiator, working as the curing agent of the epoxy resin, is a compound expressed by a generic formula [Chemical Formula 4], which is sulfonium salt containing non-nucleophilic anion—where the non-nucleophilic X⁻ is SbF₆⁻, PF₆⁻, BF₄⁻, AsF₆⁻, or the like. Any anion or cation having a different structure is applicable without limitation if it has a characteristic of curing the epoxy resin and reactive diluent.

[Chemical Formula 4]

Sulfonium salt cationic polymerization initiator [Product name mentioned in the Specification: SI160, SI150, etc.]

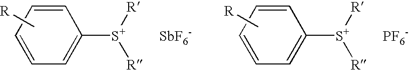

The compound expressed by the above generic expression [Chemical Formula 4] is can be used alone or in mixture of two or more types. Of the sulfonium salt cationic polymerization initiators described above, the one of which non-nucleophilic X⁻ is SbF₆⁻, PF₆⁻, or the like is preferable in view of improving the heat resistance (glass transition temperature) of cured product of the epoxy resin composition and extending the pot life. The sulfonium salt cationic polymerization initiator can be dissolved with reactive diluent prior to usage or one already dissolved with reactive diluent is also available such as the sulfonium salt cationic polymerization initiator Sun-Aid SI-100L, SI-150L and SI-160L marketed by Sanshin Chemical Industry, Co., Ltd.

Mixture of the sulfonium salt cationic polymerization initiator shall preferably be 1 to 5 by weight for 100 by weigh of the epoxy resin in view of the heat resistance (glass transition temperature) of cured product. If this mixture is less than 1 by weight, curing reactivity becomes slow, resulting in deterioration of the mechanical properties such as heat resistance and bending property and electrical properties such as tanδ.

If the mixture exceeds 5 by weight, curing reactivity becomes excessively fast and so the pot life shortens. In addition, self-heating becomes excessive during the curing of the epoxy resin composition, resulting in carbonization, and so normal cured product cannot be expected.

If the sulfonium salt cationic polymerization initiator is put together with amine compound or alkali compound, generated cationic group is collected and curing is prevented, and thereby a possibility of deteriorating the curing ability tremendously is caused and normal cured product may not be expected. Accordingly, it is not suitable for usage together with the amine compound or alkali compound.

<Reactive Diluent>

Any reactive diluent is applicable provided that it is liquid under normal temperature (25° C. to 40° C.) and it is cured or its curing reaction is progressed by the sulfonium salt cationic polymerization initiator.

For example, styrene oxide, aliphatic diglycidyl ether and aromatic diglycidyl ether, γ-butyrolactone are applicable. These are used alone or in mixture of two or more.

Mixture of the reactive diluent shall preferably be 3 to 15 by weight for 100 by weight of the epoxy resin is preferable in view of the coexistence of the lower viscosity of the epoxy resin composition and higher heat resistance of cured product. If the mixture is less than 3 by weight, lower viscosity can hardly be achieved, resulting in deterioration of the impregnation into the insulation coil and rotating machine stator. If it exceeds 15 by weight, deterioration of the heat resistance (glass transition temperature) of cured product is caused.

<Rotating Machine>

In one-piece impregnation type rotating machine, an insulation coil made of plain conductor wire formed into a specified shape and wound with insulation material is mounted into an iron core slot, and then piles and wedges are inserted into the inner circumferential grooves of the iron core slot and the insulation coil is connected at the outside edge of the iron core. After this, an assembly of the insulation coil and iron core is impregnated with epoxy resin composition under vacuum and pressure and then heat-cured so as to form the insulation coil and iron core into one piece. Accordingly, effects of reduced production process (time) and reduced component material including the epoxy resin composition can be expected as compared to a rotating machine manufactured by a conventional individual impregnation method.

In addition, since the insulation coil and iron core as well as other component parts can be bonded together with epoxy resin composition, it is durable against vibration and stress caused during the operation of the rotating machine and improved heat radiation can also be expected.

Furthermore, since use of the epoxy resin composition of the present invention improves the impregnating ability because of lower viscosity and also improves the insulation performance, durability of the rotating machine increases.

In short, since the epoxy resin composition of the present invention not only provides sufficient hardness but also penetrates into minute portions because of its low viscosity, bonding of each component part becomes tighter and, since no void is caused inside the cured product of the epoxy resin, properties such as thermal conductivity improves.

As explained above, the epoxy resin composition of the present invention realizes drastically extended pot life and can allow much lower viscosity and higher heat resistance of cured product to coexist and lower the hygroscopic property. Furthermore, use of the above epoxy resin composition for one-piece impregnation type rotating machine can improve the insulation performance of the rotating machine.

Concrete descriptions about the epoxy resin composition, insulation coil and one-piece impregnation type rotating machine are given hereunder, using respective embodiments.

Each characteristic of the epoxy resin composition of the present embodiments and comparative samples is evaluated and judged using the following measuring methods and conditions.

(1) Initial Viscosity

About 70 ml of epoxy resin composition, put in a 100-ml specimen bottle (100 mm high×30 mm in diameter) made of glass, is left to stand for 30 min in a oil bath maintained at 25° C. and 40° C., and then the initial viscosity is measured by Type B rotational viscometer (made by Tokimec Inc.)

(2) Glass Transition Temperature

Cured product of the epoxy resin composition, which has been cured under a specified curing condition (described in the text of the embodiment or in the table), is processed into a prism shape of 10 mm long×7 mm each side and its glass transition temperature is measured by TM-4000 (made by Ulvac-Riko, Inc.) at a temperature increase speed of 2° C./min.

(3) Hygroscopic Property

To measure the hygroscopic property, about 80 cc of epoxy resin composition is put in a 100-ml specimen bottle (100 mm high×30 mm in diameter) made of glass and left to stand without cap for 30 days in a room maintained at a temperature of 25° C. and relative humidity of 50%, and then whether deterioration such as deposition is caused on the epoxy resin composition is checked.

(4) Pot Life

A specified amount of the epoxy resin composition is put in a bubble viscometer (bubble viscometer conforming to JIS K7233: made of glass) and sealed with silicone rubber cap on the top, and then it is left to stand in a constant temperature bath at 40° C. Then, the number of days until the viscosity measured by the following method reaches 0.5 Pa·s is regarded as the pot life.

To measure the viscosity to be used as a criterion for the pot life, the bubble viscometer containing the epoxy resin composition is maintained at 40° C. and, after turning it upside down, the time t (s) until bubble goes up to a specified level is measured and then the viscosity η (Pa·s) of the epoxy resin composition is calculated from the following Expression [1].

In advance of the above, a factor (0.065) has been obtained from the relationship between the bubble ascending time (s) and viscosity (Pa·s) using the known viscosity reference solution specified by JIS Z8809.
η=0.065×t Expression [1]

### Embodiments 1 to 3, Comparative samples 1 to 2

The epoxy resin composition of the embodiments 1 to 3 and comparative samples 1 to 2 is produced as follows. After sulfonium salt cationic polymerization initiator (made by Sanshin Chemical Industry, Co., Ltd., Product Name SI-150, SbF₆⁻) shown in Table 1 is mixed with reactive diluent, γ-butyrolactone by 1:1 and dissolved beforehand, a specified amount of reactive diluent, aliphatic diglycidyl ether (Product Name DY-022 made by Bandico Industries, Ltd.) is measured and mixed in a 200-ml sample bottle made of glass. And then, a specified amount of bisphenol A/F type epoxy resin (made by Toto Kasei, Co., Ltd., Product Name ZX-1059) and heat-dissolved resorcin type epoxy resin (Nagase Chemtex Corp., EX-201) are mixed into it, and the temperature of the mixture is increased from room temperature up to 150° C. in 4 hours and then left to stand at 150° C. for 4 hours.

Each characteristic of the produced epoxy resin composition is evaluated. The result shows that the embodiments 1 to 3 have a viscosity as low as less than 0.36 Pa·s at 25° C. and less than 0.12 Pa·s at 40° C. The glass transition temperature (hereinafter expressed as Tg) of cured product is higher than 140° C.

The pot life at 40° C. does not exceed 0.5 Pa·s even after 200 days, and so the stability can be judged excellent.

On the other hand, Tg of the comparison sample 1 is 130° C., which is lower than that of the embodiments, because the mixture of sulfonium salt cationic polymerization initiator is as small as 0.5 by weight. The comparison sample 2 does not exhibit any effect on Tg because the mixture of sulfonium salt cationic polymerization initiator is as much as 6 by weight, but the pot life exceeds 0.5 Pa·s in 160 days, which are shorter than that of the embodiments.

As explained above, the initial viscosity of the embodiments 1 to 3 in a practical temperature range can be lowered by about 22% as compared to the comparative sample 1, Tg can be increased by about 7%, and the pot life can be effectively extended.

TABLE 1

| | | | | | Comparative | Comparative |
|---|---|---|---|---|---|---|
| | | Embodiment 1 | Embodiment 2 | Embodiment 3 | sample 1 | sample 2 |
| Bisphenol A/F type epoxy | | 30 | 30 | 30 | 30 | 30 |
| resin (ZX-1059) | | | | | | |
| Resorcin type epoxy | | 70 | 70 | 70 | 70 | 70 |
| resin (EX-201) | | | | | | |
| Sulfonium salt cationic | | 1 | 3 | 5 | 0.5 | 6 |
| polymerization initiator | | | | | | |
| (SI-150) | | | | | | |
| γ-butyrolactone | | 1 | 3 | 5 | 0.5 | 6 |
| Aliphatic diglycidyl | | 2 | 2 | 2 | 2 | 2 |
| ether (DY-022) | | | | | | |
| Initial viscosity | 25° C. | 0.36 | 0.28 | 0.22 | 0.44 | 0.20 |
| (Pa · s) | 40° C. | 0.12 | 0.10 | 0.08 | 0.14 | 0.07 |

| | | | | | |
|---|---|---|---|---|---|
| Glass transition | 140 | 142 | 144 | 130 | 145 |
| temperature [Tg] (° C.) | | | | | |
| Hygroscopic property | Absent | Absent | Absent | Absent | Absent |
| [generation of | | | | | |
| deposition] | | | | | |
| Pot life at 40° C. (days) | ≧200 | ≧200 | ≧200 | ≧200 | 160 |

Curing condition: Temperature increase RT to 150° C./4 h + Left to stand 150° C./6 h

### Embodiments 4 to 6, Comparative samples 3 to 5

The epoxy resin composition of the embodiments 4 to 6 and comparative samples 3 to 5 is produced as follows. After sulfonium salt cationic polymerization initiator (made by Sanshin Chemical Industry, Co., Ltd., Product Name SI-160) shown in Table 2 is mixed with reactive diluent, γ-butyrolactone by 1:1 and dissolved beforehand, a specified amount of reactive diluent, styrene oxide (made by Wako Pure Chemical Industries, Ltd.) is measured and mixed in a 200-ml sample bottle made of glass. And then, a specified amount of bisphenol A/F type epoxy resin (made by Nagase Chemtex Corp., Product Name PY-302-2) shown in a Table 2 and heat-dissolved resorcin type epoxy resin EX-201, methylhexahydrated acid phthalic anhydride (Product Name HN5500 made by Hitachi Chemical Industries, Ltd.) are mixed into it.

Each characteristic of the produced epoxy resin composition is evaluated. The result shows that the embodiments 4 to 6 have a viscosity as low as less than 0.40 Pa·s at 25° C. and less than 0.13 Pa·s at 40° C., and Tg of cured product is higher than 140° C. The viscosity at 25° C. of the comparative sample 3 is as high as 0.54 Pa·s because the mixture of reactive diluent is as small as 2 by weight. In addition, Tg of the comparative sample 4 is 135° C., lower than that of the embodiments because the mixture of reactive diluent is as much as 16 by weight. Furthermore, because acid anhydride curing agent is employed in the comparative sample 5, curing is insufficient and so normal cured product is not obtained, and additionally deposit is generated in the pot life test, resulting in suspicious storage stability. As explained above, the initial viscosity of the embodiments 4 to 6 in a practical temperature range can be lowered by about 35% (as compared to the comparative sample 3), Tg can be increased by about 4% (as compared to the comparative samples 4 and 5), and the pot life can be effectively extended.

TABLE 2

| | | | | | Comparative | Comparative | Comparative |
|---|---|---|---|---|---|---|---|
| | | Embodiment 4 | Embodiment 5 | Embodiment 6 | sample 3 | sample 4 | sample 5 |
| Bisphenol A/F type epoxy | | 30 | 30 | 30 | 30 | 30 | 30 |
| resin (PY-302-2)) | | | | | | | |
| Resorcin type epoxy resin | | 70 | 70 | 70 | 70 | 70 | 70 |
| (EX-201) | | | | | | | |
| Sulfonium salt cationic | | 2 | 2 | 2 | 2 | 2 | 2 |
| polymerization initiator | | | | | | | |
| (SI-160) | | | | | | | |
| γ-butyrolactone | | 2 | 2 | 2 | 2 | 2 | 2 |
| Styrene oxide | | 1 | 5 | 13 | — | 14 | 5 |
| Methyl hexahydro phthalic | | — | — | — | — | — | 95 |
| anhydride (HN-5500) | | | | | | | |
| Initial viscosity | 25° C. | 0.40 | 0.23 | 0.15 | 0.54 | 0.14 | 0.14 |
| (Pa · s) | 40° C. | 0.130 | 0.080 | 0.050 | 0.140 | 0.050 | 0.050 |

| | | | | | | |
|---|---|---|---|---|---|---|
| Glass transition | 146 | 143 | 140 | 145 | 135 | 90 |
| temperature [Tg] (° C.) | | | | | | |
| Hygroscopic property | Absent | Absent | Absent | Absent | Absent | Present |
| [generation of deposition] | | | | | | |
| Pot life at 40° C. (days) | ≧200 | ≧200 | ≧200 | ≧200 | ≧200 | ≧200 |

Curing condition: Temperature increase RT to 165° C./4 h + Left to stand 165° C./6 h

### Embodiment 7, Comparative samples 5 and 7

Production procedure of insulation coil using the new epoxy resin composition according to the present invention and the characteristic of the insulation coil are described hereunder. The insulation coil is produced from an insulation coil that is formed using conductors formed into a specified shape and wound with insulation material and then impregnated with the epoxy resin composition of the present invention and then cured.

The epoxy resin composition of the present invention is the most suitable for one-piece impregnation type rotating machine but it produces a great effect when applied to ordinary insulation coil. Even for ordinary insulation coil application, the epoxy resin composition used for impregnation is required to have low viscosity and high impregnating ability, high Tg, low hygroscopic property, and long pot life similarly as for one-piece impregnating type rotating machine.

Embodiments of an insulation coil produced using the epoxy resin composition of the present invention are described concretely hereunder.

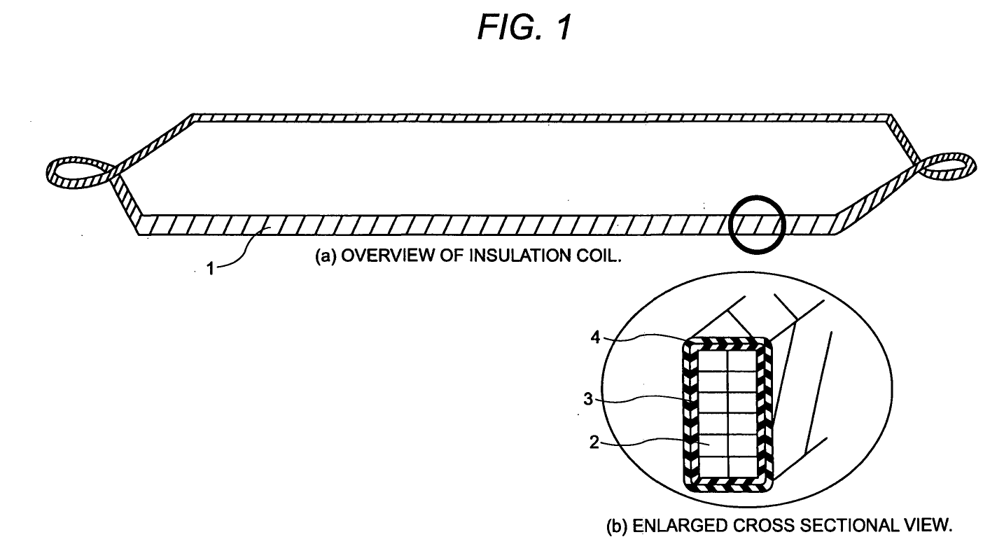

FIG. 1(a) is an overview of an insulation coil 1 produced using the epoxy resin composition of the present invention and FIG. 1(b) is an enlarged cross-sectional view of the inside of a portion encircled in FIG. 1(a).

Insulation coil is produced from insulated conductors 2 arranged in two rows and six layers that are formed into a shape in FIG. 1(a) and wound with polyester film backed mica paper tape 3 (0.13 mm thick×15 mm wide) in two turns, half-overlapped. Its outside is further wound with glass cloth tape 4 (0.18 mm thick×15 mm wide) by one turn, half-overlapped. The epoxy resin composition shown in the embodiment 1 stored under 40° C./140 days is put into an impregnation bath kept at 25° C. and the above insulation coil is immersed, and then impregnation process is performed under vacuum (10 Pa/2 h) and pressure (0.5 MPa/4 h). After this, it is cured under a condition of temperature increase from room temperature to 150° C./4 h+being left to stand at 150° C./4 h, and then cooled spontaneously down to the room temperature. Thus, the insulation coil 1 of the embodiment 7 is produced.

On the other hand, the insulation coil of the comparative sample 6 is produced in the same procedure as for the embodiment 7 except that the epoxy resin composition of the embodiment 1, which is left to stand at 40° C./140 days, is used. The insulation coil of the comparative sample 7 is produced also in the same procedure as for the embodiment 7 except that the epoxy resin composition of the embodiment 2, which is left to stand at 40° C./140 days, is used.

The insulation coils of the embodiment 7, comparative sample 6 and comparative sample 7 are heated to deteriorate at 210° C./20 days and subjected to an electrical insulation test for measuring tanδ characteristic (applied voltage: 1 to 4 kV) at 135° C. The result shows that tanδ of the insulation coil of the embodiment 7 is 3%. On the other hand, tanδ of the insulation coil of the comparative sample 6 is 6%, showing excessive deterioration because it uses the epoxy resin composition of the comparative sample 1 having lower Tg. The insulation coil of the comparative sample 7 shows tanδ of 7% because the epoxy resin composition of the comparative sample 2 has shorter pot life and so the viscosity increases during usage, resulting in poor impregnating ability.

As explained above, because the insulation coil of the embodiment 7 uses the epoxy resin composition of the embodiment 1 having lowered viscosity and improved Tg, tanδ can be held lower and insulation performance improves.

### Embodiment 8, Comparative samples 7 and 8

Another embodiment of an insulation coil produced using other epoxy resin composition of the present invention is described hereunder. The embodiment 8 of the present invention is produced in the same procedure as for the embodiment 7 except that the epoxy resin composition of the embodiment 6, which is left to stand at 40° C./200 days, is used and that it is cured under a condition of temperature increase from room temperature to 165° C./4 h+being left to stand at 165° C./4 h.

The comparative sample 8 is produced in the same procedure as for the embodiment 8 except that the epoxy resin composition of the comparative sample 3, which is left to stand at 40° C./200 days, is used.

The comparative sample 9 is produced in the same procedure as for the embodiment 7 except that the epoxy resin composition of the comparative sample 4, which is left to stand at 40° C./200 days, is used.

The insulation coils of the embodiment 8, comparative samples 7 and 8 are heated to deteriorate under the same condition as for the embodiment 7 and an electrical insulation test for measuring tanδ characteristic (applied voltage: 1 to 4 kV) at 135° C.

The result shows that tanδ of the embodiment 8 is 3%. On the other hand, tanδ of the comparative sample 7 increases to 6% because insufficient impregnation is caused due to high viscosity of the epoxy resin composition. The insulation coil of the comparative sample 8 exhibits high impregnating ability but tanδ increases to 7% because the epoxy resin composition has lower Tg.

As explained above, because the insulation coil of the embodiment 8 uses the epoxy resin composition of the embodiment 6 having extended pot life and lower viscosity, no short circuit is caused in a withstand voltage test and insulation performance improves.

### Embodiments 9 to 11

Embodiments of a one-piece impregnation type rotating machine produced using the epoxy resin composition of the present invention are described hereunder.

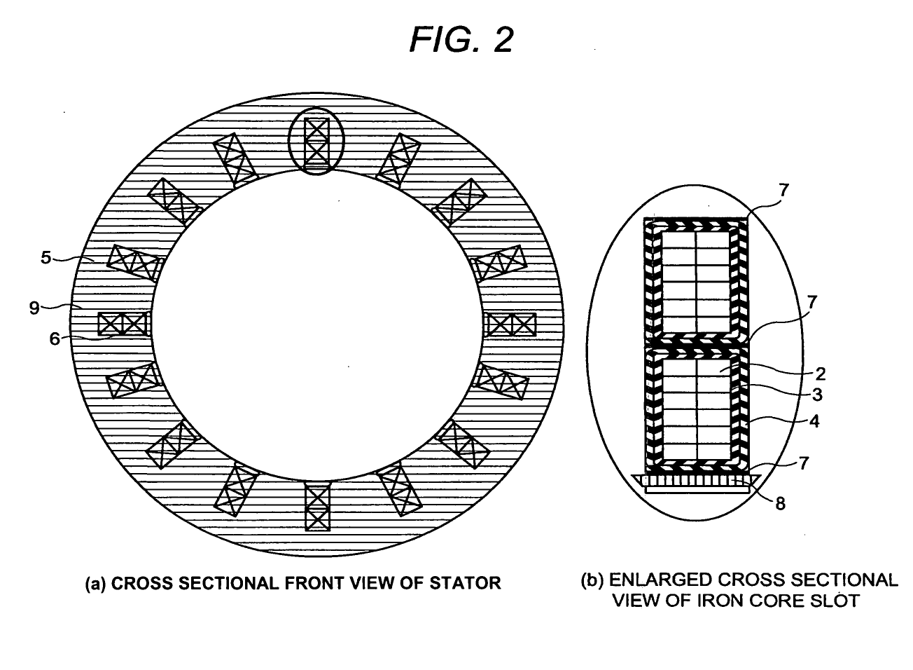

FIG. 2(a) is a cross-sectional front view of the stator of one-piece impregnation type rotating machine of the present invention and FIG. 2(b) is an enlarged cross-sectional view of a portion of the iron core slot (after an insulation coil being inserted) of the stator of the present invention shown in an oval in FIG. 2(a).

The embodiment 9 is a stator of one-piece impregnation type rotating machine produced by inserting the same insulation coil as for the embodiment 7 in an iron core slot 6 and then inserting respective piles 7 and wedges 8 shown in FIG. 2(b) so as to fasten the insulation coil.

A rotor for one-piece impregnation type rotating machine is produced from the above rotor, using the epoxy resin composition of the embodiment 1, from the same impregnation process and under the same curing condition as for the insulation coil of the embodiment 7.

A rotor for one-piece impregnation type rotating machine of the embodiment 10 is similarly produced by making out the insulation coil having a same shape as that of the embodiment 8 that uses the epoxy resin composition of the embodiment 4.

A rotor for one-piece impregnation type rotating machine of the embodiment 11 is similarly produced using the same insulation coil of the embodiment 8 that uses the epoxy resin composition of the embodiment 6.

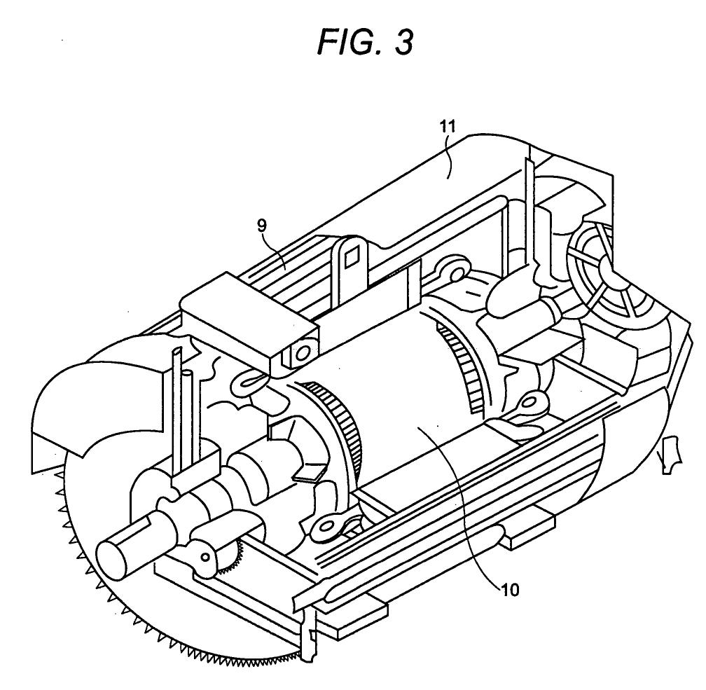

Using the stator for one-piece impregnation type rotating machine of these embodiments 9, 10 and 11, a one-piece impregnation type rotating machine 11 is assembled from the stator 9 and rotor 10 and wired accordingly as shown in FIG. 3.

Because the one-piece impregnation type rotating machine using the above embodiments 9, 10 and 11 employs the epoxy resin composition of the embodiment 1, embodiment 4 and embodiment 6 which enable much lower viscosity and higher heat resistance of cured product to coexist and of which impregnating ability and glass transition temperature are improved, the epoxy resin composition can penetrate into minute portions of the rotating machine rotor of the present invention surely in a short time. Thus, production time can be effectively reduced and insulation performance improves.

The epoxy resin composition of the present invention is provided with drastically extended pot life and produces an effect of allowing much lower viscosity and higher heat resistance of cured product to coexist and lowering hygroscopic property.

In addition, the insulation coil and one-piece impregnation type rotating machine of the present invention using the above epoxy resin composition produces an effect of improved insulation performance.

By applying the epoxy resin composition that allows much lower viscosity and higher heat resistance of cured product to coexist, the one-piece impregnation type rotating machine of the present invention has excellent electrical insulation performance.

1. A rotating machine comprising a stator and a rotor, wherein said stator has an insulation coil made of plain conductor wire formed into a specified shape and wound with insulation material, said stator being mounted into an iron core slot, with piles and wedges being inserted into the inner circumferential grooves of said iron core slot, said insulation coil being connected at the outside edge of the iron core, and an assembly of said insulation coil and iron core being impregnated with an epoxy resin composition that is a mixture of 1 to 5 percent by weight of sulfonium salt cationic polymerization initiator and 3 to 15 percent by weight of reactive diluent with 100 percent by weight of epoxy resin, said epoxy resin being liquid under normal temperature and practically containing no inorganic filler, acid curing agent or amine compound, and said epoxy resin composition being cured.

2. A rotating machine according to claim 1 comprising an epoxy resin composition which is a mixture of 1 to 5 percent by weight of sulfonium salt cationic polymerization initiator and 3 to 15 percent by weight of reactive diluent with 100 percent by weight of epoxy resin, and is liquid under normal temperature.

3. An insulation coil comprising a plain conductor wire formed into a specified shape and wound with insulation material, said insulation being manufactured by impregnating with an epoxy resin composition that is a mixture of 1 to 5 percent by weight of sulfonium salt cationic polymerization initiator and 3 to 15 percent by weight of reactive diluent with 100 percent by weight of epoxy resin, said epoxy resin composition being liquid under normal temperature and practically containing no inorganic filler, acid curing agent or amine compound, said epoxy resin composition being cured.

4. An epoxy resin composition for a one-piece impregnating type rotating machine comprising a mixture of about 1 to 5 percent by weight of sulfonium salt cationic polymerization initiator and about 3 to 15 percent by weight of reactive diluent with 100 percent by weight of epoxy resin, said epoxy resin composition being liquid under normal temperature.

5. An epoxy resin composition for a one-piece impregnating type rotating machine according to claim 4, comprising a mixture of 1 to 5 percent by weight of sulfonium salt cationic polymerization initiator and 3 to 15 percent by weight of reactive diluent with 100 percent by weight of epoxy resin, said epoxy resin being liquid under normal temperature, and containing practially no inorganic filler, acid curing agent or amine compound.

6. A rotating machine comprising a stator and a rotor;
the rotor comprising an insulation coil with a conductor covered with insulation material and an iron core,
the iron core and insulation coil being bonded together by cured epoxy resin product, and
the cured epoxy resin product being a cured epoxy resin composition that is a mixture of 1 to 5 percent by weight of sulfonium salt cationic polymerization initiator and 3 to 15 percent by weight of reactive diluent with 100 percent by weight of epoxy resin.

7. A rotating machine comprising a stator and a rotor, said stator being a plain conductor wire formed into a specified shape and covered with insulation material, said stator being inserted into an iron core slot, with piles and wedges being inserted into the inner circumferential grooves of said iron core slot, said conductor wire being connected at the outside edge of the iron core, and an assembly of said conductor wire and iron core being impregnated with an epoxy resin composition and the epoxy resin composition being cured;
the epoxy resin composition being at least a mixture of 1 to 5 percent by weight of sulfonium salt cationic polymerization initiator and 3 to 15 percent by weight of reactive diluent with 100 percent by weight of epoxy resin.

8. A method of manufacturing a rotating machine comprising a stator and a rotor, including a process for assembling an insulation coil into an iron core slot comprising
impregnating an assembled insulation coil and iron core slot with an epoxy resin composition,
said epoxy resin composition being a mixture of 1 to 5 percent by weight of sulfonium salt cationic polymerization initiator and 3 to 15 percent by weight of reactive diluent with 100 percent by weight of epoxy resin, and
curing the epoxy resin composition.
